(19) United States
(12) Patent Application Publication
(10) Pub. No.: US 2009/0210319 A1
(43) Pub. Date: Aug. 20, 2009

(54) Multi-party Commercial Web-Site and Web-Publishing Method

(75) Inventors: Mukesh Kumar Rohatgi, Laguna Niguel (CA); Cheryl L. Scudday, Villa Park, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Mazda Motor of America Inc., d/b/a Mazda North American Operations, Irvine, CA (US)

(21) Appl. No.: 12/032,529

(22) Filed: Feb. 15, 2008

(51) Int. Cl. G06Q 30/00

(52) U.S. Cl. 705/27

(57) ABSTRACT

An accessory catalog system and method for displaying an accessory catalog. The accessory catalog system may include a supplier server system, having a development server configured to serve a development interface to a vendor client over a computer network. The development interface may be configured to receive predefined types of vendor-specified data for use in displaying an accessory catalog of accessory products supplied by a supplier and sold by a vendor. The server system may further include a supplier database that is configured to store the vendor-specified data, and also to store supplier-specified data relating to the accessory products. The server system may further include a catalog server configured to serve a catalog page for display on a purchaser client of a purchaser, the catalog page including both vendor-specified data and supplier-specified data retrieved from the supplier database.

### TECHNICAL FIELD

This application relates generally to the field of Internet commerce and more particularly to facilitating cooperative Internet commerce among multiple parties.

### BACKGROUND

Two factors that contribute to a product supplier's profitability are throughput and maintenance of brand image. Effective use of the Internet may help a supplier to maximize both of these factors.

The Internet supports multi-party commerce, which may include commerce involving a supplier, a vendor, and a purchaser of a product. For example, a supplier may publish a web page that includes a catalog of products and a list of vendors organized by region. Potential purchasers are able to browse the catalog for products and to seek out vendors in their locality. The supplier web page may further include links to vendor web pages, through which the purchaser may order products. In this example, the efficiency of the ordering process may vary according to the level of resources the vendor is able to expend on web-page development. It is in the supplier's interest, however, that the receiving and filling of purchaser orders and the replenishing the vendor's inventory be as efficient as possible, since vendor efficiency contributes to supplier throughput.

In addition to receiving purchaser orders, vendor web pages may provide images and other assets of products. Uncontrolled proliferation of product images, for example, may have some disadvantages. A vendor's web page, for instance, may include a graphic or photographic catalog of a supplier's products. Naturally, the vendor may try to represent the products as accurately, informatively, and flatteringly as possible, selecting the best available images and layout. The effectiveness of the presentation may depend, however, on the level of resources invested therein, on the vendor's technical skills, and on the vendor's sense of aesthetics. Thus, uncontrolled presentation of product images may have the undesirable effect of presenting an inconsistent brand image to the consumer, which may vary depending on the resources, technical skills, and aesthetic sense of the vendor.

### SUMMARY

An accessory catalog system and a method for displaying an accessory catalog are provided. The accessory catalog system may include a supplier server system having a development server configured to serve a development interface to a vendor client over a computer network. The development interface may be configured to receive predefined types of vendor-specified data for use in displaying an accessory catalog of accessory products supplied by a supplier and sold by a vendor. The server system may further include a supplier database configured to store the vendor-specified data, and also to store supplier-specified data relating to the accessory products. The server system may further include a catalog server configured to serve a catalog page for display on a purchaser client of a purchaser, the catalog page including both vendor-specified data and supplier-specified data retrieved from the supplier database. It will be appreciated that according to some aspects, the vendor-specified data may be a vendor asset such as a graphic or photographic image, text, animation, or video, or a vendor parameter such as an inventory control parameter, vendor website address, price parameter, delivery parameter, and tax parameter.

The method may include storing supplier-specified data relating to accessory products in the accessory catalog in the database; receiving vendor-specified data for displaying the accessory catalog from a vendor via a development interface served by a development server of a supplier, and storing the vendor-specified data in a database at the supplier. The method may further include, in response to a request from a purchaser client, serving a catalog page via a catalog server, the catalog page including vendor-specified data and supplier specified data retrieved from the database.

### BRIEF DESCRIPTION OF THE DRAWINGS

FIG. 1 is a block diagram illustrating an exemplary, multi-party, commercial, web-site system in accordance with the present disclosure.

FIG. 2 is a flow chart illustrating an exemplary, multi-party, commercial, web-site publishing method in accordance with the present disclosure.

FIG. 3 and FIG. 4 are exemplary screen images of a developer interface of the system of FIG. 1, as displayed on a vendor device at a step in the method of FIG. 2.

FIG. 5 is an exemplary screen image from a purchaser's web browser when viewing an example web page created by the method of FIG. 2.

FIG. 6 is an exemplary screen image from a vendor contact input screen of the developer interface of the system of FIG. 1.

### DETAILED DESCRIPTION

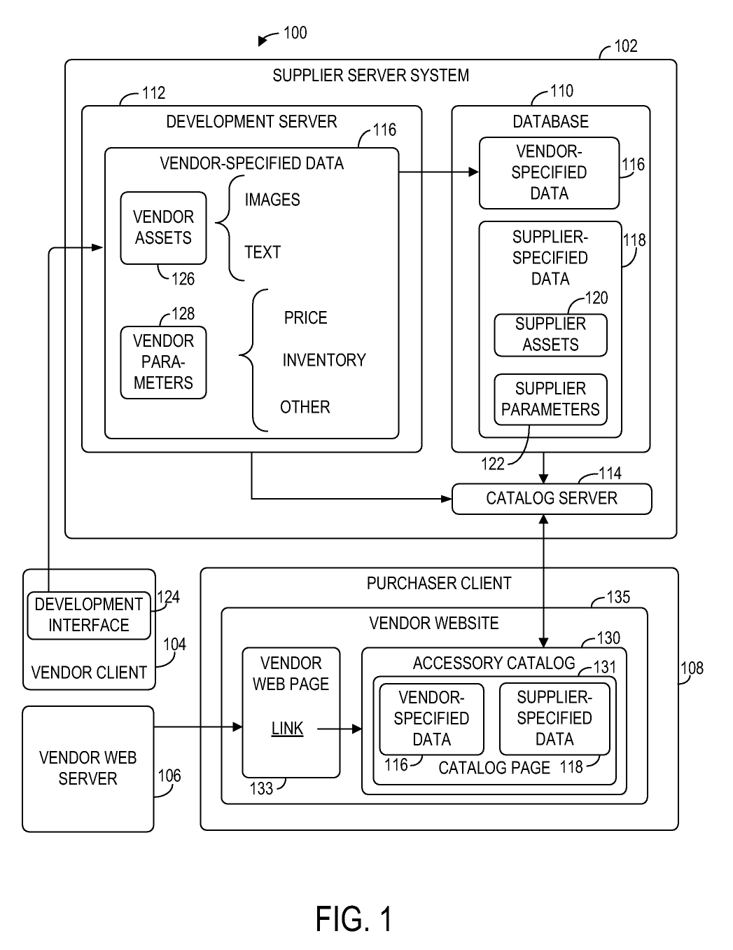

FIG. 1 is a block diagram illustrating an exemplary, multi-party, commercial, web-site system 100 in accordance with the present disclosure. FIG. 1 shows hardware components that include supplier server system 102, vendor client 104, vendor web server 106, and purchaser client 108, which variously communicate with each other via one or more computer networks 109, such as the Internet. It will be understood that these servers and clients are configured to communicate with each other using established communication protocols, such as hypertext transfer protocol (HTTP), which forms the basis for many communications on the Internet.

Supplier server system 102 includes a development server 112 configured to serve a development interface 124 to vendor client 104 over the computer network 109. As described below, the development interface is configured to receive predefined types of vendor-specified data 116 for use in displaying a catalog page 131 of an accessory catalog 130 featuring accessory products supplied by a supplier and sold by a vendor.

The supplier server system 102 further includes a supplier database 110 configured to store the vendor-specified data 116, and also to store supplier-specified data 118 relating to the accessory products, as described below. The supplier server system 102 further includes a catalog server 114 configured to serve a catalog page 131 of the accessory catalog 130 for display on a purchaser client 108 of a purchaser, the catalog page 131 including both vendor-specified data 116 and supplier-specified data 118 retrieved from the supplier database 110.

Supplier server system 102 is typically operated or managed by a supplier of a product, which also provides supplier-specified data 118. Likewise, vendor client 104 and vendor web server 106 are operated or managed by a vendor of the product, which also provides vendor-specified data 116. Purchaser client 108 is operated by a potential purchaser of the product. In one embodiment, the supplier may be an automobile manufacturer, the vendor may be an automobile dealership, and the products being sold may be the manufacturer's genuine automobile parts and accessories, also referred to as original equipment manufacturer (OEM) parts and accessories.

Supplier-specified data 118 includes one or more supplier-provided digital assets, referred to herein as supplier assets 120. Supplier assets 120 may include graphic or photographic images of the supplier's products, which, for example, may be the supplier's genuine parts or accessories. Animations and video may also be included within supplier assets 120. The images and other assets may be rendered according to a supplier standard in which attributes such as image size, image resolution, and color depth are set.

Supplier-specified data 118 may further comprise one or more supplier-provided parameters, referred to herein as supplier parameters 122. Supplier parameters 122 may include, for example, a supplier-suggested retail price associated with one or more products, and inventory information such as an indicator of the an available number of units of a product in the supplier's current inventory. Other structured data associated with the product may also be included in supplier assets 120. For example, color, trim, size, or other product attributes may be defined and associated values stored as supplier assets 120. It will be appreciated that the supplier parameters and the supplier assets may be linked, for example, on a product basis, such that product images may, for example, be associated with a textual description, manufacturer suggested retail price, inventory information, or other supplier parameter. Thus, data may be selected for presentation on a product basis, and the presentation of the displayed supplier assets and supplier parameters may be set by the supplier.

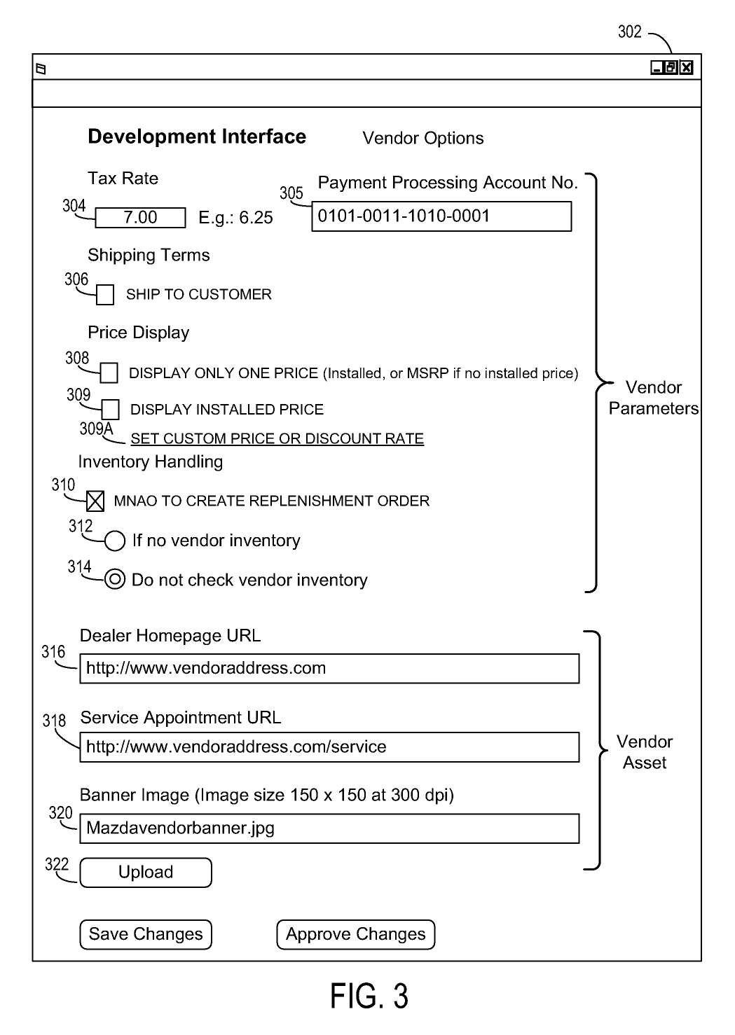

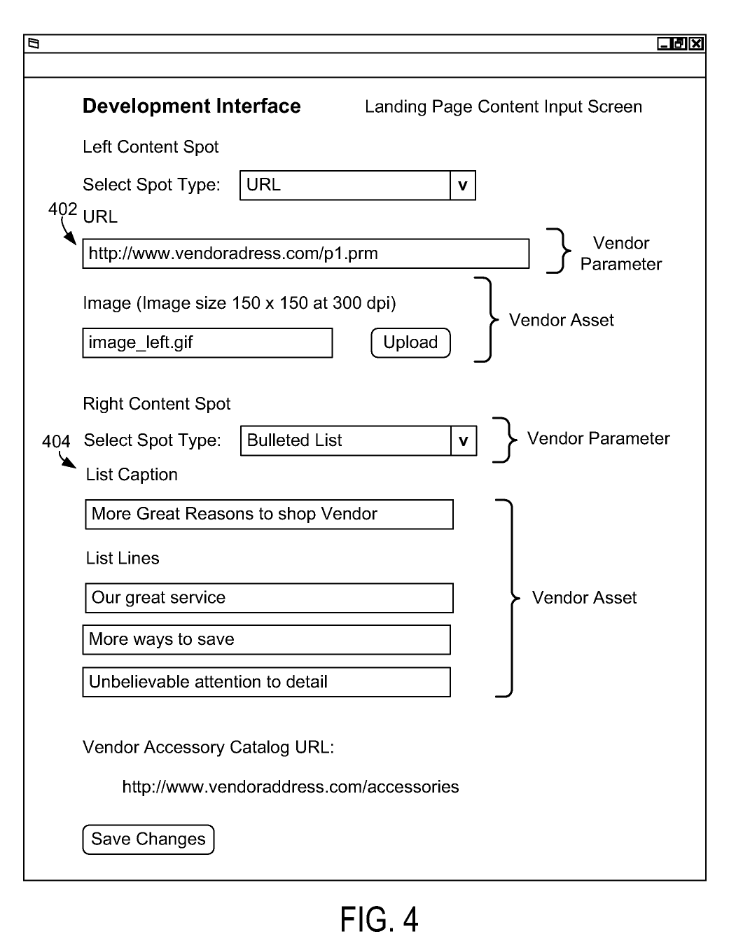

Development server 112 is configured to receive vendor-specified data 116 from vendor client 104 and to store it in database 110. Development server 112 communicates with vendor client 104 through a development interface 124, which is a graphical user interface configured with input mechanisms to enable the vendor to input the vendor-specified data 116. The development interface 124 may include, for example, a template of predefined user input mechanisms configured to receive input of the vendor-specified data, as described below in detail with respect to FIGS. 3 and 4.

Vendor-specified data 116 includes vendor assets 126 and vendor parameters 128. Vendor assets are typically digital assets such as graphic or photographic images, text, animations, and video. The vendor asset may in some embodiments include a depiction of a logo or logotype of the vendor, for example. The vendor-specified parameters may include, for example, an inventory control parameter, vendor website address, price parameter, delivery parameter, tax parameter, account number, order type (e.g., stock fulfillment order or customer requested order), discount rate, vendor name, contact first and last name, vendor email address, vendor address (street, state, country, zip code), vendor phone number, and vendor fax number. Examples of such parameters are illustrated in FIGS. 3 and 4, below. Further, in some embodiments, the vendor website address may be one or more of a homepage address and/or and a service page address, as illustrated in FIGS. 3 and 4.

In particular, vendor parameters 128 may include a price for each product in the supplier catalog that the vendor sells. For products that may be purchased with or without installation, vendor parameters 128 may include an installed price and an uninstalled price. In this manner, the vendor may specify a price for both the product and the product bundled with an associated service, such as installation.

Vendor parameters 128 may further include promotional and market-specific data concerning products that the vendor obtains from the supplier. Examples of such data may include multiple price options, such as promotional and sale prices, for specific products and a price application parameter, such as a range of time and/or dates, and/or a range of localities (such as zip codes), over which those products may be offered at each price option. Thus, a sale price may be specified by the vendor to be offered after a holiday season, at night, or in a strategically identified geographic area, for example.

Vendor parameters 128 may further include a determination of which modes of delivery of the product to make available to potential purchasers. Modes of delivery may include shipment, express shipment, and will-call at the place of business of the vendor.

Vendor parameters 128 may further include inventory control information, such as a determination of how the vendor's inventory may be replenished by the supplier following the sale of a product to a purchaser. Inventory control information may further include a determination of whether a commercial transaction may be enabled by supplying the product from an inventory of the supplier if the product is not available in the inventory of the subject vendor. For example, as illustrated in FIG. 3, the vendor may elect to have the supplier automatically ship a product not in vendor stock in order to facilitate a potential order. Or, the vendor may elect to “opt-in” to shipment from the supplier to the vendor of a product not in vendor stock.

Finally, vendor parameters 128 may include an account number through which the vendor may be credited for products purchased via the accessory catalog 130. The account may be, for example, an account number at a financial transaction processor, such as a bank or electronic payment company. In this manner, the third-party supplier of the financial transaction processing service may receive payment information from a purchaser of a product, and credit the payment for the product to the vendor directly using the account number on file for the vendor.

In addition to receiving vendor-specified data 116 and passing it through to database 110, development server 112 is configured to enable the construction of an accessory catalog in which data from supplier-specified data 118 and data from vendor-specified data 116 may be presented on the same catalog page. Development server 112 creates the accessory catalog 130 of this mixed-source web content, which is in turn hosted on supplier server system 102 through catalog server 114.

Catalog server 114 may, in a non-limiting example, store hypertext markup language (HTML) data created by development server 112, which derives from or draws on the data stored in database 110. In creating mixed-source web content within accessory catalog 130, development server 112 may be configured to enforce a supplier presentation rule for formatting and presenting mixed-source data. In some examples, development server 112 may implement the supplier presentation rule using web-page templates, style sheets, and/or software, such as embedded scripting languages. The supplier rule may address various formatting or presentation issues, for example, the supplier presentation rule may specify:

i. a permitted range of dates when data from the first asset may be presented;

ii. a range of allowed display resolutions for presenting image data from the first asset;

iii. text fonts, sizes and colors;

iv. background images; and

v. format and layout of the page.

Development server 112 may further include software to facilitate interoperability and exchangeability of data between the supplier and multiple vendors. For instance, development server 112 may include software to process a purchaser's order based on a vendor's local inventory. If the product is not present in the vendor's local inventory, the software may allow the purchaser to take stock from the supplier's inventory, according to the vendor specified parameters 128 described above.

In some examples, the vendor may create other web content independently, and may display this web content on a vendor web page 133 of a vendor website 135, which is served by vendor web server 106.

Finally, development server 112 is further configured such that the accessory catalog 130 it creates will enable a commercial transaction between the vendor and a purchaser according to the vendor parameters described above.

Purchaser client 108 is shown in FIG. 1 accessing vendor website 135 through a web browser application. Vendor website 135 includes a vendor web page 133 and accessory catalog 130 including catalog pages 131 on which respective product information may be displayed. The catalog pages 131 are typically accessible via a link in the vendor web page 133. The vendor web page is typically served by a vendor web server 106, while as discussed above, the accessory catalog 130 is typically served by catalog server 114. In some embodiments, the vendor web page 133 and the catalog pages 131 are accessible at respective first and second uniform resource locators (URLs), i.e., Internet addresses, which share a top and second level domain name, and the first and second URLs respectively map to each of the vendor web server 106 and the catalog server 114. In this manner, the purchaser may access both the vendor web page 133 and the accessory catalog 130 seamlessly, without interruption, and without the outward appearance of having traveled to a different website.

It will be appreciated that the vendor web page 133 and accessory catalog pages 131 are typically displayed in different browser windows. Alternatively they may be displayed in different frames of the same browser window.

The accessory catalog 130 may include a subset of selected data from vendor-specified data 116 and a subset of selected data from supplier-specified data 118, the selection being based on, for example, a received purchaser selection of a product catalog entry to view. On accessing accessory catalog 130, purchaser client 108 will thus be presented with data from vendor-specified data 116 and data from supplier-specified data 118, but subject to a supplier-specified formatting and presentation rule. However, the commercial transactions enabled by accessory catalog 130 will be governed by vendor parameters that form vendor-provided commercial transaction rules.

The arrangement of system components in FIG. 1, which illustrates an interaction involving one supplier, one vendor, and one purchaser, does not exclude the participation of other parties as well. In particular, it is contemplated that the embodiment of FIG. 1 may be expanded by inclusion of additional vendors, purchasers, and/or suppliers, similar in form and function and in to those described herein and similar also in their relationships to each other.

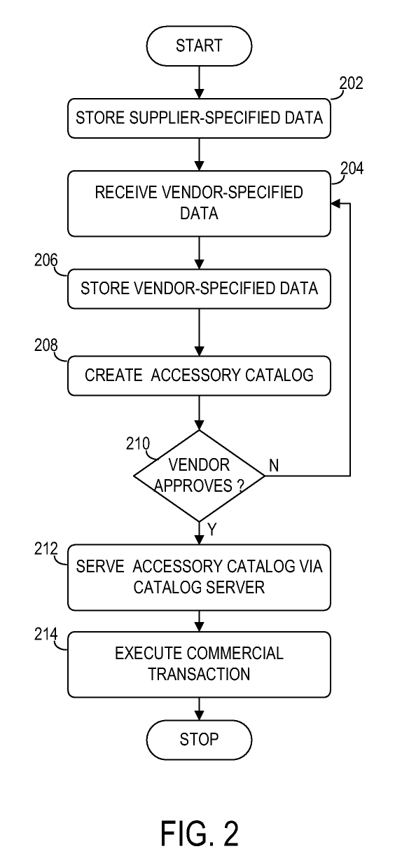

FIG. 2 is a flow chart illustrating an exemplary, multi-party, commercial web site publishing method in accordance with the present disclosure. It will be appreciated that the methods described hereinafter may be implemented using the systems described above, or other suitable componentry. For clarity, each of the steps in the method of FIG. 2 may be understood as being described from a point of view of the supplier.

At 202, the method includes storing in a database supplier-specified data relating to accessory products in an accessory catalog. At 204, the method includes receiving vendor-specified data for displaying the accessory catalog from a vendor via a development interface served by a development server of a supplier. At 206, the method includes storing the vendor-specified data in the database at the supplier.

At 208, the method may include creating an accessory catalog using the vendor-specified data and the supplier-specified data. At 210, vendor approval of the accessory catalog is solicited, via development interface, and, if the vendor approves of the accessory catalog, then at 212 the method includes, in response to a request from a purchaser client, serving a catalog page of the accessory catalog via a catalog server, the catalog page including vendor-specified data and supplier-specified data that has been retrieved from the database. At 214, the supplier, by way of the accessory catalog, executes a commercial transaction involving the vendor and a purchaser, in which payment information is processed as described above.

FIG. 3 and FIG. 4 are exemplary screen images from a development interface 124 of the system of FIG. 1, that may be used in step 208 to create an accessory catalog as describe above. In these example screens, the supplier is an automobile manufacturer and the vendor is an automobile dealership. The products being sold are the manufacturer's genuine automobile parts and accessories.

FIG. 3 shows input mechanisms 304-322 which enable the vendor to enter vendor parameters governing a commercial transaction between the vendor and a purchaser, and vendor assets to be presented therein. In particular, input mechanisms 304-308 enable the vendor to enter a regional tax rate via a tax rate input mechanism 304, to enter payment information in the form of a payment processing account number via payment information input mechanism 305, to determine whether a product purchased through the web page may be shipped to the customer via delivery method input mechanism 306, and whether to display the installed price of the product or the uninstalled price via price input mechanisms 308 and 309. A selector 309A may be provided by which the vendor may set a custom price for a product or select to apply a discount rate to the suggested retail price for a product. Inventory control parameter input mechanisms 310-314 are configured to receive a determination from the vendor of how the vendor's inventory will be replenished. If input mechanism 310 is checked, the supplier will automatically generate a replenishment order. If input mechanism 312 is checked, the replenishment order will be generated only if the sale of a product would result in depleting the vendor's inventory of that product. Input mechanisms 316 and 318 allow the vendor to enter URL (Internet address) of the vendor home page and the vendor service department, respectively. Input mechanisms 320 and 322 enable the vendor to upload a vendor-specified banner or logo.

FIG. 4 shows another screen image from the development interface 124. FIG. 4 shows first and second input mechanisms 402, 404. Each of the first and second input mechanisms includes a URL input field and an image upload control. The vendor may specify a vendor asset for upload or a vendor parameter (such as a URL) at which a vendor asset is located. By inputting this information, the vendor may specify respective vendor assets that may be displayed on a catalog page 131 of the accessory catalog 130. In this manner, the vendor may upload images such as vendor logos or vendor facilities photos for the purpose of customizing the mixed-source web content.

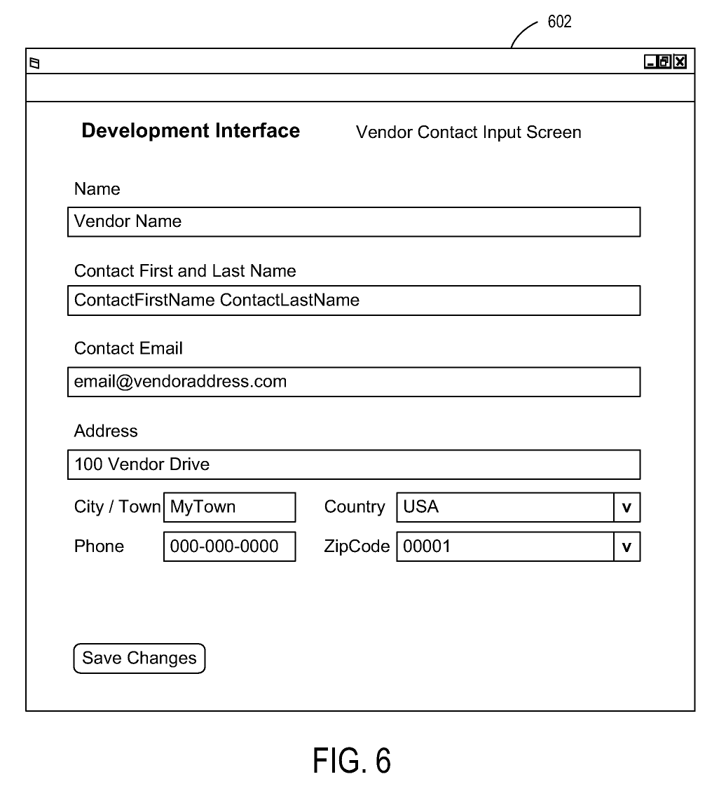

FIG. 6 illustrates a vendor contact information input screen 602 of development interface, by which a vendor may input various contact information, such as vendor name, contact name (first and last), contact email address, and vendor address (including street address, city, state, zip code, and country).

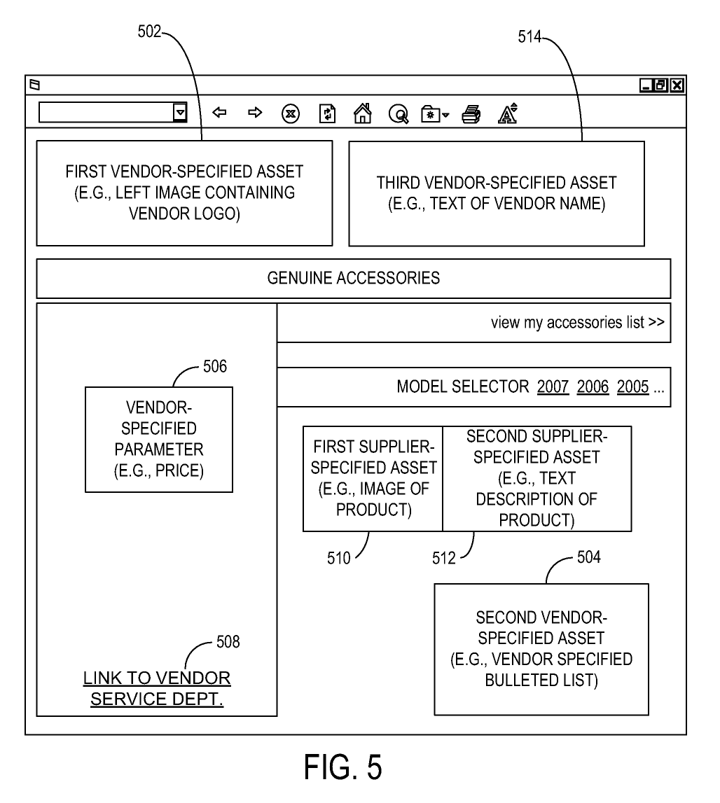

FIG. 5 is an exemplary screen image displayed on purchaser 108, illustrating an example accessory catalog 130 created via the development interface 124 illustrated in FIGS. 3 and 4. FIG. 5 includes image 502 and bulleted list 504, which are the assets chosen by the vendor and entered via the controls of FIG. 4, as well as a textual vendor asset 514 which may, for example, include the vendor name. A vendor parameter 506 may be displayed, indicating a vendor-specified price for a product. Further, a link 508 to a vendor service department may be provided, to enable customer to schedule service appointments, for example. In addition, first and second supplier assets 510, 512, which may be an image and text description of the product, may be displayed.

In this manner the above described systems and methods may be used to efficiently create and display an accessory catalog featuring content both specified by the supplier and by the vendor, thereby enabling the supplier to control the presentation quality while enabling the vendor to customize the presentation details to its satisfaction, thereby overcoming the disadvantages of the prior art.

It should be understood that the designations ‘product,’ ‘supplier,’ and ‘vendor’ referred to herein are arbitrary and non-limiting. The ‘product’ could instead be a service (i.e., a repair service); the ‘supplier’ could instead be a distributor or a franchiser; and the ‘vendor’ could be any kind of franchisee. It must further be understood that the systems and methods described herein are exemplary in nature, and that these specific embodiments or examples are not to be considered in a limiting sense, because numerous variations are contemplated. Accordingly, the present disclosure includes all novel and non-obvious combinations of the various systems and methods disclosed herein, as well as any and all equivalents thereof.

1. An accessory catalog system, comprising a supplier server system, including:
a development server configured to serve a development interface to a vendor client over a computer network, the development interface being configured to receive predefined types of vendor-specified data for use in displaying an accessory catalog of accessory products supplied by a supplier and sold by a vendor;
a supplier database configured to store the vendor-specified data, and also to store supplier-specified data relating to the accessory products; and
a catalog server configured to serve a catalog page for display on a purchaser client of a purchaser, the catalog page including both vendor-specified data and supplier-specified data retrieved from the supplier database.

2. The system of claim 1, wherein the vendor-specified data includes a vendor asset.

3. The system of claim 2, wherein the vendor asset is selected from the group consisting of an image, graphic, text, animation, and video.

4. The system of claim 3, wherein the vendor asset includes a depiction of a logo of the vendor.

5. The system of claim 1, wherein the vendor-specified data includes vendor parameters.

6. The system of claim 5, wherein the vendor-specified parameters are selected from the group consisting of an inventory control parameter, vendor website address, price parameter, delivery parameter, and tax parameter.

7. The system of claim 6, wherein the vendor website address is selected from the group consisting of a homepage address and a service page address.

8. The system of claim 1, wherein the supplier-specified data includes supplier assets selected from the group consisting of graphic or photographic images, text, video, and animations.

9. The system of claim 1, wherein the supplier-specified data includes supplier parameters selected from the group consisting of manufacturer suggested retail price, and inventory information.

10. The system of claim 1, wherein the development interface includes a template of predefined user input mechanisms configured to receive input of the vendor-specified data.

11. The system of claim 1, wherein the catalog page is accessible via a link in a vendor web page served by a vendor web server.

12. The system of claim 1, wherein the vendor web page and the catalog page are accessible at respective first and second uniform resource locators that share a top and second level domain name, the first and second uniform resource locators respectively mapping to each of the vendor web server and the catalog server.

13. A method for displaying an accessory catalog, the method comprising:
storing supplier-specified data relating to accessory products in an accessory catalog in a database;
receiving vendor-specified data for displaying the accessory catalog from a vendor via a development interface served by a development server of a supplier;
storing the vendor-specified data in the database at the supplier; and
in response to a request from a purchaser client, serving a catalog page via a catalog server, the catalog page including vendor-specified data and supplier specified data retrieved from the database.

14. The method of claim 1, wherein the vendor-specified data includes a vendor asset.

15. The method of claim 14, wherein the vendor asset is selected from the group consisting of an image, graphic, text, animation, and video.

16. The method of claim 15, wherein the vendor asset includes a depiction of a logo of the vendor.

17. The method of claim 1, wherein the vendor-specified data includes vendor parameters.

18. The method of claim 17, wherein the vendor-specified parameters are selected from the group consisting of an inventory control parameter, vendor website address, price parameter, delivery parameter, and tax parameter.

19. The system of claim 18, wherein the vendor website address is selected from the group consisting of a homepage address and a service page address.

20. An accessory catalog system, comprising a supplier server system, including:
a development server configured to serve a development interface configured to receive vendor-specified data from a vendor, the development interface a template of predefined user input mechanisms configured to receive input of the vendor-specified data; and
wherein the vendor-specified data includes a vendor asset selected from the group consisting of an image, graphic, text, animation, and video; and
wherein the vendor-specified data includes a vendor parameter selected from the group consisting of an inventory control parameter, vendor website address, price parameter, delivery parameter, and tax parameter.
